(19) United States
(12) Patent Application Publication
(10) Pub. No.: US 2025/0091930 A1
(43) Pub. Date: Mar. 20, 2025

(54) CLAMPING DEVICES AT EDGE OF SUBSTRATE GLASS DURING MOLDING BASED ON OVERFLOW TECHNIQUE AND OPERATION METHODS THEREOF

(71) Applicant: CAIHONG DISPLAY DEVICES CO., LTD., Xianyang (CN)

(72) Inventors: Weidong HU, Xianyang (CN); Zhijun ZHANG, Xianyang (CN); Yongjing REN, Xianyang (CN); Ting LUO, Xianyang (CN)

(73) Assignee: CAIHONG DISPLAY DEVICES CO., LTD., Xianyang (CN)

(21) Appl. No.: 18/970,772

(22) Filed: Dec. 5, 2024

Related U.S. Application Data
(63) Continuation-in-part of application No. PCT/CN2024/092905, filed on May 13, 2024.

(30) Foreign Application Priority Data
Jun. 19, 2023 (CN) 202310729332.2

(51) Int. Cl. C03B 35/20; C03B 23/037; C03B 35/16

(52) U.S. Cl. CPC C03B 35/20; C03B 23/037; C03B 35/162

(57) ABSTRACT

Disclosed is a clamping device at an edge of a substrate glass during molding based on an overflow technique and an operation method thereof. The clamping device comprises a primary clamping unit and a secondary edge drawing unit that are clamped on edges of two sides of a glass plate, respectively. The primary clamping unit is arranged above the secondary edge drawing unit and is closer to a guide plate than the secondary edge drawing unit. The operation method comprises during the molding of the glass plate, enabling clamping wheels of the primary clamping unit and wheels for cooling and edge drawing of the secondary edge drawing unit to clamp the edges of the two sides of the glass plate to make liquid glass at the edges merge and bond together to obtain a bonded glass plate; and introducing cooling air to cool edges of the bonded glass plate.

### CROSS-REFERENCES TO RELATED APPLICATIONS

This application is a continuation-in-part of International Patent Application No. PCT/CN2024/092905, filed on May 13, 2024, which claims priority to Chinese Patent Application No. 202310729332.2, filed on Jun. 19, 2023, the entire contents of each of which are incorporated herein by reference.

### TECHNICAL FIELD

The present disclosure relates to the field of substrate glass manufacturing based on an overflow technique, and in particular to a clamping device at an edge of a substrate glass during molding based on the overflow technique.

### BACKGROUND

With the continuous development of liquid crystal display to higher generations, the market demand for large-size substrate glass is increasing. The mainstream technology for production of a substrate glass based on an overflow technique today is to make a high-temperature molten glass flow out of both sides of an overflow device to converge at a brick point and fully bond to form a glass plate with smooth sides. However, for production of the substrate glass, the increase in plate width and the increase in plate drawing speed may lead to an increase in the difficulty of molding quality control. Due to the rapid cooling of an edge drawing machine, the edge portion is prone to hollowing (i.e., poor bonding or misalignment), and under the simultaneous action of clamping by the edge drawing machine and the inward contraction of the glass plate, it is easy to experience a sudden change in thickness and create weak areas. In addition, the cooling air of the edge drawing machine is liable to affect the temperature field of the drainage region, causing crystallization.

Therefore, it is desirable to provide a clamping device at an edge of a substrate glass during molding based on an overflow technique and an operation method thereof to suppress the inward shrinkage of the glass plate, ensure the effective plate width of the substrate glass, and ensure that the glass does not contact other objects in the effective region, thereby ensuring the smoothness of the glass surface.

### SUMMARY

One of the embodiments of the present disclosure provides a clamping device at an edge of a substrate glass during molding based on an overflow technique. The clamping device may comprise a primary clamping unit and a secondary edge drawing unit. The primary clamping unit and the secondary edge drawing unit may clamp the edges of two sides of a glass plate, respectively. The primary clamping unit may be arranged above the secondary edge drawing unit. The primary clamping unit may be closer to a guide plate than the secondary edge drawing unit.

One of the embodiments of the present disclosure further provides an operation method of a clamping device at an edge of a substrate glass during molding based on an overflow technique. The clamping device may include a primary clamping unit and a secondary edge drawing unit. The primary clamping unit and the secondary edge drawing unit may clamp edges of two sides of a glass plate, respectively. The primary clamping unit may be arranged above the secondary edge drawing unit. The primary clamping unit may be closer to a guide plate than the secondary edge drawing unit. The operation method may comprise: during the molding of the glass plate, enabling clamping wheels of the primary clamping unit and wheels for cooling and edge drawing of the secondary edge drawing unit to clamp the edges of the two sides of the glass plate to make liquid glass at the edges merge and bond together to obtain a bonded glass plate, and introducing cooling air into a cooling air duct to cool edges of the bonded glass plates.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a structural diagram illustrating a front view of a clamping device at an edge of a substrate glass during molding based on an overflow technique according to some embodiments of the present disclosure;

FIG. 2 is a schematic diagram illustrating a partial section of a glass of a clamping device at an edge of a substrate glass during molding based on an overflow technique according to some embodiments of the present disclosure;

FIG. 3 is a structural diagram illustrating a side view of a clamping device at an edge of a substrate glass during molding based on an overflow technique according to some embodiments of the present disclosure;

FIG. 4 is a structural diagram illustrating an exemplary secondary edge drawing unit according to some embodiments of the present disclosure;

FIG. 5 is a schematic diagram illustrating an application scenario of a processor according to some embodiments of the present disclosure;

FIG. 6 is a schematic diagram illustrating a drawing part according to some embodiments of the present disclosure; and

FIG. 7 is a schematic diagram illustrating a clamping model according to some embodiments of the present disclosure.

Reference signs: 10—primary clamping unit, 11—clamping wheels, 20—secondary edge drawing unit, 21—wheels for cooling and edge drawing, 22—cooling air duct, 23—refrigeration device, 24—air outlet duct, 25—spiral tube, 30—glass plate, 31—glass plate edge region, 32—liquid glass, 33—glass plate edge clamping region, 41—guide plate, 42—overflow brick, 50—processor, 60—drawing part, 61—electronic control unit, 62—slide rail, 63—pulley, 64—locking part.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system,” “device,” “unit” and/or “module” used herein are a way to distinguish between different components, elements, parts, sections, or assemblies at different levels. However, the terms may be replaced by other expressions if other words accomplish the same purpose.

In the description of the embodiments of the present disclosure, it should be noted that if the terms “upper,” “lower,” “horizontal,” “inner,” etc. appear, the orientation or position relationship indicated is based on the orientation or position relationship shown in the drawings, or is the orientation or position relationship in which the product of present disclosure is usually placed when used. It is only for the convenience of describing present disclosure and simplifying the description, and does not indicate or imply that the device or element referred to must have a specific orientation, be constructed and operated in a specific orientation, and therefore cannot be understood as a limitation to the present disclosure.

In the description of the embodiments of the present disclosure, it is also necessary to explain that, unless otherwise clearly specified and limited, the terms “set,” “install,” “connect,” and “connection” should be understood in a broad sense, for example, it can be a fixed connection, a detachable connection, or an integral connection; it can be a mechanical connection or an electrical connection; it can be a direct connection, or it can be an indirect connection through an intermediate medium, or it can be an internal connection of two components. For those having ordinary skills in the art, the specific meanings of the above terms in the present disclosure can be understood according to specific circumstances.

During the molding of a substrate glass based on an overflow technique, uneven or hollow edges are prone to occur during the molding of edges. Therefore, the present disclosure provides a clamping device at an edge of a substrate glass during molding based on an overflow technique and an operation method thereof, which can promote the bonding of the edges of a high-temperature glass, improve the quality of the edges of the glass plate, and enhance the production stability of the edges of the formed glass plate.

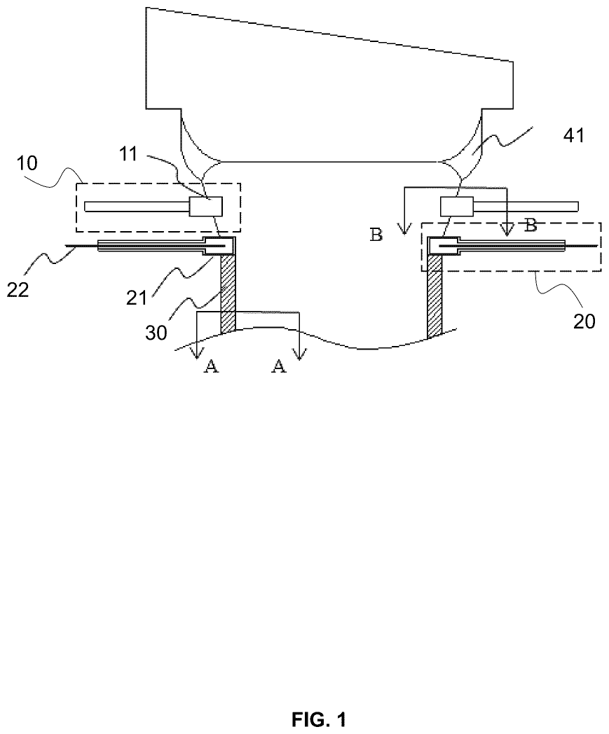

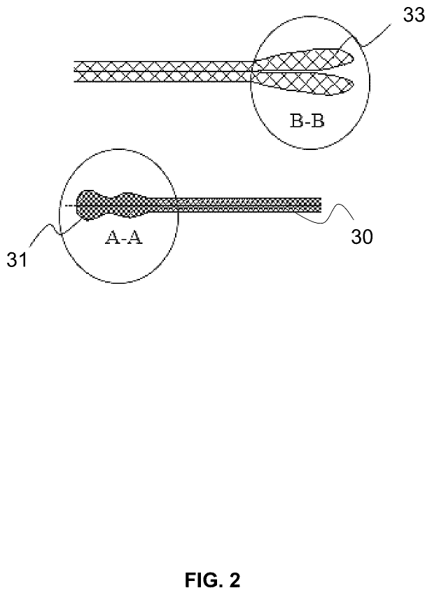

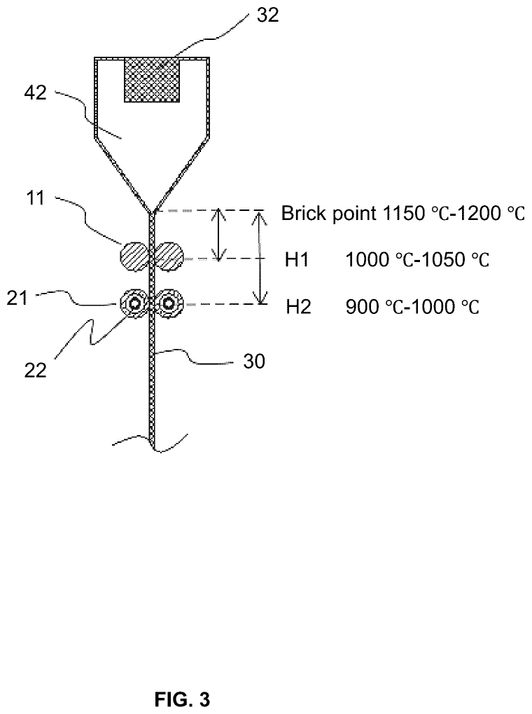

FIG. 1 is a structural diagram illustrating a front view of a clamping device at an edge of a substrate glass during molding based on an overflow technique according to some embodiments of the present disclosure. FIG. 2 is a schematic diagram illustrating a partial section of a glass of a clamping device at an edge of a substrate glass during molding based on an overflow technique according to some embodiments of the present disclosure. FIG. 3 is a structural diagram illustrating a side view of a clamping device at an edge of a substrate glass during molding based on an overflow technique according to some embodiments of the present disclosure.

In some embodiments, as shown in FIG. 1 to FIG. 3, the clamping device at the edge of the substrate glass during molding based on the overflow technique (hereinafter referred to as the clamping device) may include a primary clamping unit 10 and a secondary edge drawing unit 20. The primary clamping unit 10 and the secondary edge drawing unit 20 may clamp edges of two sides of a glass plate 30, respectively. The primary clamping unit 10 may be arranged above the secondary edge drawing unit 20. The primary clamping unit 10 may be closer to a guide plate 41 than the secondary edge drawing unit 20.

The glass plate 30 refers to a target product molded by a molten liquid glass through the overflow technique. The guide plate 41 is a structural member for guiding the flow of the molten liquid glass. The guide plate 41 is usually located above or on a side of the molten liquid glass to help control a flow rate and a flow direction of the molten liquid glass.

The primary clamping units 10 may be configured to clamp the edges of the glass plate 30 to ensure that the glass plate 30 does not move or deform during the production process. The primary clamping units 10 may perform preliminary drawing on the edges of the glass plate.

In some embodiments, as shown in FIG. 1 to FIG. 3, the primary clamping unit 10 may include clamping wheels 11. The clamping wheels 11 may be solid roller wheels. Materials of the clamping wheels 11 may be a metal material or a ceramic material.

During molding of the glass plate based on the overflow technique, the molten liquid glass is about 1300° C., so the metal material selected for the clamping wheels 11 is a high-temperature resistant metal. For example, the metal material corresponding to the clamping wheel 11 may include molybdenum, chromium alloy, or the like, which can operate stably at a high temperature of 1300° C.

The clamping wheel 11 is a wheel structure for clamping the edge of the glass plate. In some embodiments, the primary clamping unit 10 may include one or more pairs of clamping wheels 11. Each pair of clamping wheels may be disposed on two sides of the glass plate 30, and the clamping wheels arranged opposite to each other may clamp the edge of the glass plate by pressure or friction. For example, as shown in FIG. 3, the primary clamping unit 10 may include two clamping wheels 11 arranged opposite to each other.

In some embodiments, as shown in FIG. 1, the clamping wheels 11 may be disposed below the guide plate 41, so as to prevent the influence of the secondary edge drawing unit 20 located below the clamping wheels 11 on the guide plate 41.

The secondary edge drawing unit 20 may be configured to further draw and adjust the edge of the glass plate 30 to ensure that the edge of the glass plate 30 reaches the required accuracy and shape.

In some embodiments, as shown in FIG. 1 and FIG. 3, the secondary edge drawing unit 20 may include wheels 21 for cooling and edge drawing. The wheels 21 for cooling and edge drawing may be hollow roller wheels.

The wheels 21 for cooling and edge drawing may be configured to draw the edge of the glass plate 30 and shape the edge of the glass plate by cooling. A cavity of each of the wheels 21 for cooling and edge drawing may be configured to accommodate a cooling medium. The cooling medium may include cooling air or cooling liquid.

In some embodiments, the secondary edge drawing unit 20 may include one or more pairs of wheels 21 for cooling and edge drawing. Each pair of wheels 21 for cooling and edge drawing may be symmetrically arranged on the two sides of the glass plate 30. For example, as shown in FIG. 3, a pair of wheels 21 for cooling and edge drawing may be symmetrically arranged in the secondary edge drawing unit 20, and the pair of wheels 21 for cooling and edge drawing may clamp the edges of the two sides of the glass plate 30, respectively. The symmetrically arranged wheels 21 for cooling and edge drawing can help draw and cool the edges of the glass plate more uniformly, so as to avoid cracks or deformation of the glass plate caused by thermal stress.

In some embodiments, an interior of each of the wheels 21 for cooling and edge drawing may be provided with a cavity whose wall thickness meets a preset condition. The preset condition may be that a difference between a maximum value and a minimum value of the wall thickness of the cavity is less than a difference threshold. The difference threshold may be set based on experience. If the wall thickness of the cavity meets the preset condition, it means that the wall thickness is uniform, so the cooling is more uniform.

In some embodiments, a cooling air duct 22 may be inserted into the cavity of each of the wheels 21 for cooling and edge drawing. The secondary edge drawing unit 20 may quickly cool the edge of the glass plate 30 through the cooling air duct 22.

The cooling air duct 22 is a pipe device for conveying the cooling air.

In some embodiments, the cooling air may be introduced into the cooling air duct 22.

During the drawing process of the glass plate 30, the cooling air enters the wheels 21 for cooling and edge drawing through the cooling air duct 22 and fills the cavity of each of the wheels 21 for cooling and edge drawing. The cooling air can take away the heat generated by the contact between the wheels 21 for cooling and edge drawing and the molten liquid glass, thereby cooling the molten liquid glass and promoting molding of the edges of the glass plate.

The cooling air duct and the wheels 21 for cooling and edge drawing operate together to cool the glass plate while preventing the edges of the glass plate from warping or other morphological defects, thereby enhancing the drawing effect.

In some embodiments, the glass plate 30 may be divided into a plurality of temperature fields in sequence from the guide plate 41 downward according to a preset temperature range. The primary clamping unit 10 may clamp the edge of the glass plate located in the first temperature field.

The temperature fields are regions composed of different temperature ranges on the glass plate 30. The preset temperature range may be set according to experience and needs. During the molding of the glass plate based on the overflow technique, the temperature of the liquid glass is about 1300° C.-1600° C. After the liquid glass overflows from the guide plate 41 and flows downward, the temperature of the liquid glass gradually decreases. An initial cooling temperature is about 1000° C.-1200° C., and the liquid glass gradually becomes a molten state. In a molding and drawing stage, a drawing temperature is about 800° C.-1000° C. The preset temperature range may be divided according to the same temperature gradient or different temperature gradients. For example, the preset temperature range may include 1150° C.-1200° C., 1000° C.-1050° C., 900° C.-1000° C., or the like.

The first temperature field is a temperature field where the clamping position of the primary clamping unit 10 on the glass plate 30 is located. In some embodiments, the first temperature field may be a first preset temperature range. The first preset temperature range may be set based on experience. For example, the first preset temperature range is 1000° C.-1050° C., or the like. Merely by way of example, as shown in FIG. 3, the height from each of the clamping wheels 11 of the primary clamping unit 10 to a brick point of an overflow brick 42 is H1, a temperature range of a temperature field where the brick point of the overflow brick 42 is located is 1150° C.-1200° C., and a temperature range of the glass plate at H1 below the brick point of the overflow brick 42 is 1000° C.-1050° C. The first preset temperature range may also be set to any other temperature range.

When the primary clamping unit 10 is located in the first temperature field, a glass plate edge region of the glass plate 30 is not cooled, and the two sides of the glass plate are bonded together by the clamping function of the clamping wheels 11 to ensure the bonding quality.

The overflow brick 42 is a device for controlling the flow of the liquid glass. The overflow brick 42 guarantees that the thickness of the liquid glass 32 is uniform during the overflow process, which helps maintain the stability of the molten glass and prevents excessive liquid glass overflow. The overflow brick 42 may be located below the guide plate 41. The guide plate 41 may be configured to guide the liquid glass 32 to move toward the overflow brick 42. The liquid glass 32 flows uniformly downward through the brick point of the overflow brick 42.

In some embodiments, the glass plate 30 may be divided into a plurality of temperature fields in sequence from the guide plate 41 downward according to the preset temperature ranges. The secondary edge drawing unit 20 may clamp the edge of the glass plate located in a second temperature field.

The second temperature field is a temperature field where a clamping position of the secondary edge drawing unit 20 on the glass plate 30 is located. In some embodiments, the second temperature field may be a second preset temperature range. The second preset temperature range may be set based on experience, and the temperatures in the second preset temperature range may be lower than the temperatures in the first preset temperature range. For example, the second preset temperature range is 900° C.-1000° C. As another example, the second preset temperature range is 950° C.-1000° C., or the like. The second preset temperature range may also be set to any other temperature range.

In some embodiments, the secondary edge drawing unit 20 may be below the primary clamping unit 10, a height from the secondary edge drawing unit 20 to the brick point may be H2, and a temperature range of the glass plate at H2 below the brick point is the second preset temperature range. H2 may be greater than H1. When the secondary edge drawing unit is located in the second temperature field, the shrinkage of the glass plate in a width direction can be suppressed by rapid cooling to ensure the thickness of the edges of the glass plate and the width of the glass plate.

In some embodiments, as shown in FIG. 2 and FIG. 3, the liquid glass 32 flows downward uniformly from two sides of the overflow brick 42 and converges at the brick point. The liquid glass at the middle region may be well bonded together to form the glass plate 30. In a glass plate edge clamping region 33, due to the cooling and inward contraction of the glass plate 30, the edges of the glass plate may not be well bonded, and a B-B cross-sectional shape as shown in FIG. 2 may appear. Therefore, at the position of the height H1 from the brick point, the temperature of the glass plate 30 is 1000° C.-1050° C., and a pair of solid clamping wheels 11 are used to clamp the two sides of the glass plate, respectively, such that the edges of the glass plate quickly converge and bond together, and no wetting occurs between the clamping wheels 11 and the glass plate 30.

In some embodiments, as shown in FIG. 3, at the position of the height H2 from the brick point, the temperature range of the glass plate is 900° C.-1000° C., and a pair of wheels 21 for cooling and edge drawing are used to clamp the two sides of the glass plate 30, respectively. Meanwhile, the cooling air is introduced into the cooling air duct 22 to quickly cool a glass plate edge region 31 to form a glass plate A-A cross-section shown in FIG. 2, i.e., an ideal region without hollowness, misalignment, or thickness mutation. Since the clamping wheels 11 are located above the wheels 21 for cooling and edge drawing, the clamping wheels 11 can prevent the temperature influence of the wheels 21 for cooling and edge drawing on the guide plate 41, avoiding the devitrification deterioration in the region of the guide plate 41. In addition, compared to the conventional technology, the glass temperature at the clamping height of the wheels 21 for cooling and edge drawing is relatively high, which can well promote glass bonding and reduce the influence of the shrinkage of the glass plate 30 on the width of the glass plate.

With the joint effect of the primary clamping unit and the secondary edge drawing unit, a better state of the edges of the glass plate can be formed, so as to improve the production stability.

Some embodiments of the present disclosure include but are not limited to the following beneficial effects. (1) The bonding of the high-temperature edges of the glass plate is promoted through the primary clamping unit, and rapid cooling of the edges of the glass plate is guaranteed through the secondary edge drawing unit to form a certain clamping thickness, and the shrinkage of the width of the glass plate is suppressed, thereby achieving the purpose of improving the bonding quality of the edges of the glass plate, improving the clamping effect, and stabilizing the production quality. (2) Under the joint effect of the clamping wheels and the wheels for cooling and edge drawing, a better state of the edges of the glass plate is formed, such that the production stability is improved, and the bonding of the high-temperature edges of the glass plate is promoted. In addition, the situations where the clamping position at the edge of the glass plate is too low, and the clamping region of the glass plate is poorly bonded due to the temperature drop, which leads to quality defects of hollowness, misalignment, and the thickness mutation between the edges of the glass plate and the effective transition region can be improved, such that the clamping stability and production stability of the edges during molding are improved, and the adverse effects such as broken plate and cracks in the cross-cutting of the subsequent process are eliminated. (3) The clamping wheels are arranged above the wheels for cooling and edge drawing, which can prevent the temperature influence of the wheels for cooling and edge drawing on the guide plate, avoiding the devitrification deterioration in the region of the guide plate. (4) The glass temperature at the clamping height of the wheels for cooling and edge drawing is high, which can effectively promote glass bonding and reduce the influence of the width shrinkage of the glass plate on the clamping quality.

It should be noted that the above description of the clamping device and the components thereof is only for convenience of description and does not limit the present disclosure to the scope of the embodiments. It is understood that after understanding the principle of the device, those skilled in the art may arbitrarily combine the components or form a subsystem connected to other components without deviating from the principle.

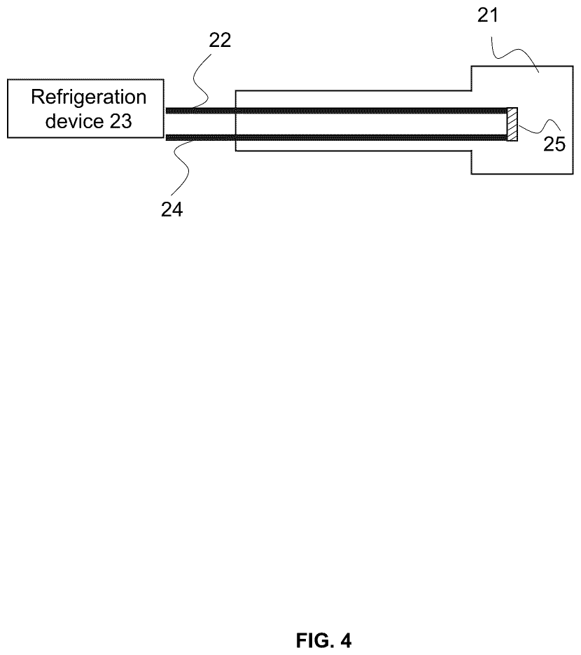

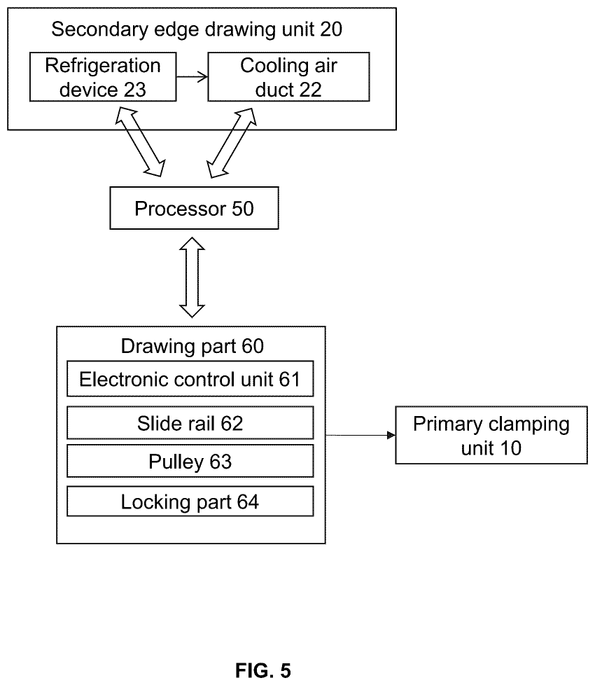

FIG. 4 is a structural diagram illustrating an exemplary secondary edge drawing unit according to some embodiments of the present disclosure. FIG. 5 is a schematic diagram illustrating an application scenario of a processor according to some embodiments of the present disclosure.

In some embodiments, as shown in FIG. 4 and FIG. 5, the cooling air duct 22 may be connected with a refrigeration device 23. The refrigeration device 23 may be configured to generate cooling air. The refrigeration device 23 may be in communication with a processor 50. The processor 50 may be configured to control the refrigeration device 23 and the cooling air duct 22 to generate the cooling air.

More descriptions regarding the cooling air duct 22 and the cooling air may be found in the related descriptions of FIG. 1 to FIG. 3. More descriptions regarding the processor 50 may be found in FIG. 5 below.

The refrigeration device 23 is a device for providing the cooling air to the cooling air duct. For example, the refrigeration device 23 may include a compressor, a condenser, an evaporator, a circulation pipeline, etc. The evaporator may be configured in a refrigeration air container to absorb heat in the air by evaporation of a refrigerant in the circulation pipeline.

In some embodiments, the cooling air duct 22 and the refrigeration device 23 may be connected in various ways, such as a mechanical connection, or the like.

In some embodiments, the refrigeration device 23 may include a cooling fan. The cooling fan is a device for conveying the cooling air. The cooling air generated by the refrigeration device 23 may be conveyed to the cooling air duct 22 through the cooling fan to cool the liquid glass.

In some embodiments, the processor 50 may obtain one or more parameters related to the refrigeration device 23. The refrigeration device 23 may obtain a parameter adjustment instruction sent by the processor 50. The parameters related to the refrigeration device 23 may include the power of the refrigeration device 23, the power of the cooling fan, etc. The parameter adjustment instruction refers to an instruction to adjust the parameters related to the refrigeration device.

In some embodiments, the processor 50 may be further configured to adjust the temperature of the cooling air by controlling the cooling power of the refrigeration device 23 and adjust the airflow speed of the cooling air by controlling an operation parameter of the cooling fan.

The cooling power reflects the ability of the refrigeration device 23 to remove heat from the environment. The greater the cooling power, the greater the ability of the refrigeration device 23 to remove heat from the environment. In some embodiments, the cooling power of the refrigeration device 23 may be negatively correlated with the temperature of the cooling air.

The temperature of the cooling air refers to a temperature of the cooling air when the cooling air enters the cooling air duct 22.

In some embodiments, the processor 50 may determine a current temperature of the cooling air based on a current ambient temperature and a glass temperature by referring to a preset temperature table.

The current ambient temperature is a temperature of the environment in which the glass plate is currently located. The processor 50 may obtain the current ambient temperature through a temperature sensor disposed in the environment. The preset temperature table may include a correspondence between an ambient temperature range, a glass temperature range, and the temperature of the cooling air. The preset temperature table may be constructed based on historical data. For example, for a temperature of the cooling air, the processor 50 may count a historical ambient temperature range and a historical glass temperature range when the glass plate produced at this temperature does not have any quality problems subsequently as a correspondence in the preset temperature table. The preset temperature table may be established by traversing a plurality of correspondences. The quality problems may include hollowness, stratification, devitrification, etc.

The operation parameter of the cooling fan refers to a parameter related to operation of the cooling fan. In some embodiments, the operation parameter of the cooling fan may include the power of the cooling fan, or the like. The airflow speed of the cooling air may be positively correlated with the power of the cooling fan.

The airflow speed refers to a flow speed of the cooling air in the cooling air duct. For example, the airflow speed is 2 m/s.

In some embodiments, the processor 50 may use an initial airflow speed as the airflow speed of the cooling air, and adjust the airflow speed of the cooling air by controlling the power of the cooling fan until the airflow speed reaches the initial airflow speed. The initial airflow speed may be preset based on experience or historical data.

In some embodiments of the present disclosure, the processor 50 may generate the cooling air by controlling the refrigeration device 23, so as to optimize the cooling process of the edges of the glass plate, reduce the thermal stress of the edges of the glass plate during molding, and improve the product quality.

In some embodiments, the processor 50 may determine the airflow speed based on the temperature of the cooling air, a liquid glass flow speed, and a glass cooling rate.

The liquid glass flow speed refers to a speed at which the liquid glass flows during the production process of the glass plate. For example, the liquid glass flow speed may be 1 m/s. In some embodiments, the liquid glass flow speed may be directly measured using a flowmeter, or calculated by measuring a flow distance of the liquid glass within a certain period of time. The flowmeter may be an electromagnetic flowmeter or an ultrasonic flowmeter.

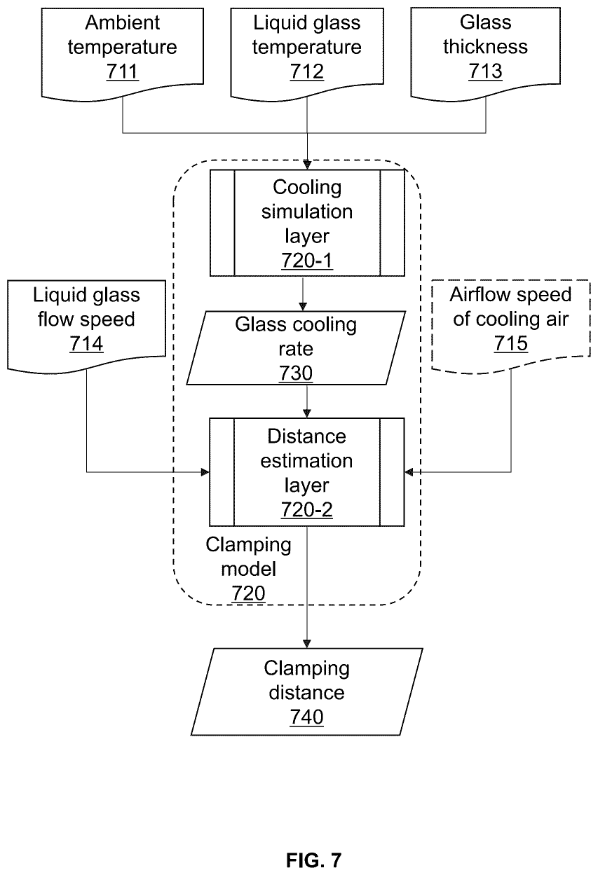

The glass cooling rate refers to a speed at which the temperature of the liquid glass decreases during the cooling process. For example, the glass cooling rate may be 2° C./s. In some embodiments, the glass cooling rate may be obtained by a freezing simulation layer of a clamping model. More descriptions regarding the clamping model may be found in FIG. 7 and related descriptions thereof.

In some embodiments, the processor 50 may determine an adjusted airflow speed of the cooling air through a preset algorithm based on the temperature of the cooling air, the liquid glass flow speed, and the glass cooling rate. More descriptions regarding the temperature of the cooling air may be found in the related descriptions of FIG. 4 and FIG. 5 above.

In some embodiments, the airflow speed of the cooling air may be negatively correlated with a temperature change rate of the cooling air and a change rate of the glass cooling rate and may be positively correlated with a change rate of the liquid glass flow speed. For example, the preset algorithm may be expressed by the following formula (1):

$$V = v * ( 1 - {k}_{1} * A + {k}_{2} * B - {k}_{3} * C ) , \qquad ( 1 )$$

where V denotes the adjusted airflow speed of the cooling air, v denotes the airflow speed of the cooling air before adjustment, A denotes the temperature change rate of the cooling air, B denotes the change rate of the liquid glass flow speed, C denotes the change rate of the glass cooling rate, and k₁, k₂, and k₃ denote coefficients greater than 0.

The change rate may be a statistical value. For example, the statistical value is an average value. For example, if time point 1 and time point 2 are taken as two consecutive time points, the value of time point 1 is M, and the value of time point 2 is N, the change rate is a result obtained by dividing an absolute value of a difference between N and M by M.

In some embodiments, k₁, k₂, and k₃ may be determined by a linear fitting technique. For example, the processor 50 may substitute historical data of a plurality of correct airflow speeds after adjustment in the historical data into the formula (1) to calculate k₁, k₂, and k₃. The plurality of correct airflow speeds after adjustment refer to airflow speeds that have quality problems before the adjustment and do not have quality problems after the adjustment. The historical data may include historical airflow speeds of the cooling air after the adjustment, historical airflow speeds of the cooling air before the adjustment, historical temperature change rates of the cooling air, historical liquid glass flow speed change rates, and historical glass cooling rate change rates.

In some embodiments, the processor 50 may adjust the initial airflow speed to the adjusted airflow speed of the cooling air by adjusting the power of the cooling fan. In some embodiments, the processor 50 may periodically determine and adjust the airflow speed of the cooling air. An adjustment period may be preset based on experience. For example, the adjustment period is once every 1 min or once every 10 min.

In some embodiments of the present disclosure, the processor precisely controls the operation parameter of the cooling fan and dynamically adjusts the airflow speed based on the temperature of the cooling air, the liquid glass flow speed, and the glass cooling rate, so as to optimize the cooling effect and improve the quality and efficiency of the edge molding of the glass plate.

In some embodiments of the present disclosure, the processor can optimize the temperature and the airflow speed of the cooling air by precisely controlling the refrigeration power and the cooling air duct of the refrigeration device, thereby more effectively removing the heat from the glass plate and improving the cooling efficiency.

In some embodiments, as shown in FIG. 4 and FIG. 5, the secondary edge drawing unit 20 may further include an air outlet duct 24 and a spiral tube 25. One end of the spiral tube 25 may be communicated with the cooling air duct 22, and the other end of the spiral tube 25 may be communicated with the air outlet duct 24. The air outlet duct 24 and the spiral tube 25 may be configured to discharge the cooling air.

The air outlet duct 24 is an air duct for guiding the cooling air from the cooling air duct 22 to an external environment. In some embodiments, the air outlet duct 24 may be connected with the spiral tube 25 to discharge the cooling air, and the cooling air may take away the heat in the secondary edge drawing unit 20. The air outlet duct 24 may be provided to prevent the cooling air escaping from the wheels 21 for cooling and edge drawing from affecting the temperature of the guide plate 41 and the temperature of the upstream glass, thereby avoiding production quality problems.

The spiral tube 25 is a spiral pipeline for connecting the cooling air duct 22 and the air outlet duct 24. The spiral tube 25 may increase a contact area between the cooling air and a tube wall of the spiral tube 25 in a limited space, thereby improving the heat exchange efficiency and reducing the production cost.

In some embodiments of the present disclosure, by reasonably controlling the temperature and the airflow speed of the cooling air, the processor can effectively avoid the problem of quality fluctuation of the glass plate caused by excessive cooling or insufficient cooling of the cooling air. By pre-adjusting and timely adjusting the temperature and the airflow speed of the cooling air, the processor can avoid the production quality problems caused by untimely regulation.

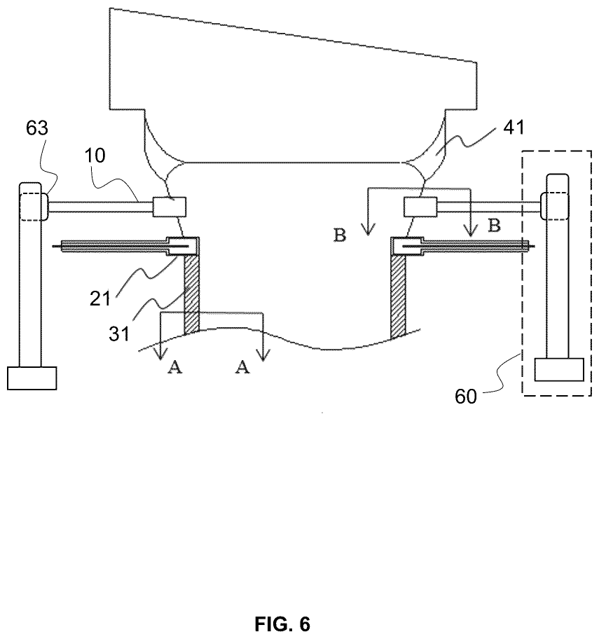

FIG. 6 is a schematic diagram illustrating a drawing part according to some embodiments of the present disclosure.

In some embodiments, as shown in FIG. 5 and FIG. 6, the clamping device may further include the processor 50 and a drawing part 60. The drawing part 60 may be connected with the primary clamping unit 10. The processor 50 may be in communication with the drawing part 60. The processor 50 may be configured to adjust a clamping distance between the primary clamping unit 10 and the secondary edge drawing unit 20 through the drawing part 60.

The drawing part 60 is a mechanical component, or the like, for adjusting the clamping distance.

In some embodiments, the drawing part 60 may be connected with the primary clamping unit 10 in various ways, such as a mechanical connection, or the like. For example, the drawing part 60 may be slidably connected with the primary clamping unit 10. The primary clamping unit 10 is slidable on the drawing part 60.

The processor 50 is a device for processing data and/or information related to the clamping device. The processor 50 may execute program instructions based on the data and/or the information related to the clamping device to perform one or more functions described in the present disclosure. In some embodiments, the processor 50 may include at least one of a central processing unit (CPU), an application specific integrated circuit (ASIC), or the like.

The clamping distance refers to a vertical distance between the primary clamping unit 10 and the secondary edge drawing unit 20. For example, as shown in FIG. 3, the clamping distance between the primary clamping unit 10 and the secondary edge drawing unit 20 may be H2-H1. H2-H1 may be set to 50 mm, or the like.

In some embodiments, the processor 50 may obtain a pressure between the glass plate 30 and the primary clamping unit 10, and dynamically adjust the clamping distance in response to determining that the pressure is greater than a pressure threshold.

In some embodiments, the processor 50 may obtain the pressure between the glass plate 30 and the primary clamping unit 10 based on a pressure sensor. In response to determining that the pressure is greater than the pressure threshold, the processor 50 may control the primary clamping unit 10 to move away from the secondary edge drawing unit 20 by the drawing part to increase the clamping distance. A high pressure between the glass plate 30 and the primary clamping unit 10 indicates that the hardness of the glass plate is high, and the primary clamping unit may not operate well. The closer to the guide plate, the lower the hardness of the glass plate, so it is necessary to increase the clamping distance to make the primary clamping unit closer to the guide plate so as to clamp the edge of the glass plate earlier.

The pressure sensor may be disposed on the primary clamping unit 10. An adjustment amplitude of the primary clamping unit 10 may be positively correlated with an amplitude of a pressure exceeding the pressure threshold. The pressure threshold may be preset by those skilled in the art based on experience.

In some embodiments, the clamping device may further include an alarm component. When the molding process of the glass plate edge clamping region 33 is abnormal, an alarm is sounded through the alarm component. The processor 50 may use a pressure measured by the pressure sensor when the primary clamping unit 10 sounds an alarm as the pressure threshold. In some embodiments, the processor may monitor a glass temperature at a clamping position of the primary clamping unit 10 based on a temperature sensor, and determine that the molding process of the glass plate edge clamping region 33 is abnormal in response to determining that the glass temperature is less than a temperature threshold. The temperature threshold may be set based on experience. If the glass temperature at the clamping position of the primary clamping unit 10 is low, it means that the liquid glass cools down quickly after leaving the overflow brick, the hardness of the glass plate at the clamping position of the primary clamping unit 10 may be great, and the primary clamping unit 10 may not operate well.

In some embodiments, as shown in FIG. 5 and FIG. 6, the drawing part 60 may include an electronic control unit 61, a slide rail 62, a pulley 63, and a locking part 64. The locking part 64 may be configured to lock the position of the primary clamping unit 10. The processor 50 may be further configured to control, through the electronic control unit 61, the pulley 63 to slide in the slide rail 62 to drive the primary clamping unit 10 to move to adjust the clamping distance.

The electronic control unit 61 is a unit for monitoring and controlling the drawing part 60. In some embodiments, the electronic control unit 61 may control the sliding of the pulley 63 and monitor the operation of the locking part 64.

The slide rail 62 is a part that provides a sliding track for the pulley 63 and supports and guides the sliding of the primary clamping unit 10.

The pulley 63 is a sliding part matched with the slide rail 62. The pulley may be slidably disposed on the slide rail. The primary clamping unit may be connected with the slide rail.

The locking part 64 is a mechanical device for locking the primary clamping unit 10 on the drawing part 60. In some embodiments, after the pulley 63 moves to a desired position, the primary clamping unit 10 is locked by the locking part 64 to fix the position of the pulley 63.

In some embodiments, the processor 50 may control, through the electronic control unit 61, the pulley 63 to slide in the slide rail 62 to drive the primary clamping unit 10 connected with the pulley 63 to be close to or away from the secondary edge drawing unit 20, and lock the primary clamping unit 10 at different positions through the locking part 64, so as to obtain different clamping distances.

In some embodiments of the present disclosure, with the coordinated operation of the electronic control unit, the slide rail, the pulley, and the locking part, the processor can accurately control the movement of the primary clamping unit to adjust the clamping distance, thereby improving the production efficiency and the versatility of the clamping device.

If the ambient temperature is different, the liquid glass temperature and the liquid glass cooling rate are also different, and the hardness, plasticity, and ductility of the liquid glass at the position of the primary clamping unit are also different. By reasonably determining the clamping distance, the problem that the primary clamping unit is unable to clamp normally due to different ambient temperatures and fluctuations in the liquid glass temperature can be effectively avoided, thereby reducing the probability of subsequent stratification, hollowness, devitrification, or other problems of the glass plate.

FIG. 7 is a schematic diagram illustrating a clamping model according to some embodiments of the present disclosure.

In some embodiments, as shown in FIG. 7, the processor 50 may be further configured to determine a clamping distance 740 through a clamping model 720 based on an ambient temperature 711, a liquid glass temperature 712, a glass thickness 713, and a liquid glass flow speed 714.

The ambient temperature refers to a temperature of the surrounding environment during the molding of the glass plate based on the overflow technique. For example, the ambient temperature is 25° C. In some embodiments, the processor 50 may obtain the ambient temperature through a temperature sensor disposed in the environment.

The liquid glass temperature refers to a temperature of a liquid glass when the liquid glass flows out of a brick point of the overflow brick 42. In some embodiments, the liquid glass temperature may be obtained through a high-temperature monitoring device. For example, the high-temperature monitoring device is an infrared temperature monitor. The infrared temperature monitor may be disposed at a position of the overflow brick 42 near the brick point of the overflow brick 42.

The glass thickness refers to the thickness of the glass plate after molding. For example, the glass thickness may be in a range of 1 mm-10 mm. In some embodiments, the glass thickness may be obtained by preset or monitoring. The processor 50 may obtain the thickness of a target glass plate uploaded by a user through a user terminal as the glass thickness.

More descriptions regarding the clamping distance may be found in FIG. 5 and FIG. 6 and the related descriptions thereof. More descriptions regarding the liquid glass flow speed may be found in FIG. 4 and FIG. 5 and the related descriptions thereof.

The clamping model refers to a model for determining the clamping distance between the primary clamping unit 10 and the secondary edge drawing unit 20. In some embodiments, the clamping model 720 may be a machine-learning model. For example, the clamping model may include one or more of a deep neural network (DNN) model, a neural network (NN) model, a recurrent neural network (RNN) model, or the like.

In some embodiments, an input of the clamping model may include the ambient temperature, the liquid glass temperature, the glass thickness, and the liquid glass flow speed. An output of the clamping model may include the clamping distance between the primary clamping unit and the secondary edge drawing unit.

In some embodiments, the processor 50 may train a clamping model based on a large number of first training samples and first labels corresponding to the first training samples. For example, the processor may obtain a large number of first training samples and the first labels corresponding to the first training samples as a training data set and perform a plurality of iterations. In response to determining that an iteration end condition is met, the iteration is ended and a trained model is obtained. At least one of the plurality of iterations may include: selecting one or more first training samples from the training data set and inputting one or more first training samples into the clamping model to obtain model prediction outputs corresponding to the one or more first training samples; substituting the model prediction outputs and the corresponding first labels into the formula of a predefined loss function to calculate values of the loss function; and reversely updating model parameters of the model based on the values of the loss function. Reverse updating may be achieved in various ways, such as updating by gradient descent. The iteration end condition may be that the loss function converges, a count of iterations reaches a threshold, etc.

In some embodiments, each set of the first training samples may include a sample ambient temperature, a sample liquid glass temperature, a sample glass thickness, and a sample liquid glass flow speed in historical data.

In some embodiments, the first labels corresponding to each set of training samples may include a sample clamping distance between a sample primary clamping unit and a sample secondary edge drawing unit. In some embodiments, the processor may perform a plurality of control experiments based on different clamping distances, and select a clamping distance corresponding to a control experiment with the optimal subsequent molding effect of the glass plate as the first label.

In some embodiments, a period of determining the clamping model may be consistent with an adjustment period of the airflow speed of the cooling air. The adjustment period of the airflow speed of the cooling air may be found in the related descriptions of FIG. 4 and FIG. 5.

In some embodiments, the clamping model 720 may include a cooling simulation layer 720-1 and a distance estimation layer 720-2.

In some embodiments, as shown in FIG. 7, the processor 50 may estimate the glass cooling rate 730 through the cooling simulation layer 720-1 based on the ambient temperature 711, the liquid glass temperature 712, and the glass thickness 713, and estimate the clamping distance 740 through the distance estimation layer 720-2 based on the liquid glass flow speed 714 and the glass cooling rate 730.

The cooling simulation layer is a model for estimating the glass cooling rate. In some embodiments, the cooling simulation layer may be a machine learning model, such as a neural network (NN) model, or the like.

In some embodiments, an input of the cooling simulation layer 720-1 may include the ambient temperature 711, the liquid glass temperature 712, and the glass thickness 713, and an output of the cooling simulation layer 720-1 may include the glass cooling rate 730.

More descriptions regarding the glass cooling rate may be found in FIG. 4 and the related descriptions thereof.

In some embodiments, the cooling simulation layer may be obtained based on a large number of second training samples with second labels. The second training samples for training the cooling simulation layer may include a sample ambient temperature, a sample liquid glass temperature, and a sample glass thickness. The second labels may include actual glass cooling rates corresponding to the second training samples.

In some embodiments, the second training samples may be obtained based on historical data generated in a historical production process. The historical data may include a historical ambient temperature, a historical liquid glass temperature, and a historical glass thickness. In some embodiments, the processor may use a change of the liquid glass temperature change between two consecutive time points monitored historically as the second label.

In some embodiments, the specific training process of the cooling simulation layer may be similar to the training process of the clamping model and may be found in the related descriptions above, which are not repeated here.

The distance estimation layer is a model for estimating the clamping distance. In some embodiments, the distance estimation layer may be a machine learning model, such as an RNN model, or the like.

In some embodiments, an input of the distance estimation layer 720-2 may include the liquid glass flow speed 714 and the glass cooling rate 730, and an output of the distance estimation layer 720-2 may include the clamping distance 740.

More descriptions regarding the glass cooling rate and the clamping distance may be found in FIG. 4 and FIG. 5 and the related descriptions thereof.

In some embodiments, the distance estimation layer may be obtained based on a large number of third training samples with third labels. The third training samples for training the distance estimation layer may include a sample glass cooling rate and a sample liquid glass flow speed. The third labels may include clamping distances corresponding to the third training samples.

In some embodiments, the third training samples may be obtained based on the historical data of the historical production process. The historical data may include a historical liquid glass flow speed and a historical glass cooling rate. In some embodiments, the processor 50 may use an average value of clamping distances corresponding to the third training samples in the historical data when the glass plate has no quality problems in the subsequent production process as the third label.

In some embodiments, the processor 50 may generate the third labels according to a count of alarms issued by the primary clamping unit 10 corresponding to different third training samples. For example, an average value of clamping distances corresponding to the third training samples in the historical data when no alarm occurs or the count of alarms is less than a preset count threshold may be used as the third label corresponding to the third training sample. The preset count threshold may be set according to historical experience. For example, the preset count is 3. In some embodiments, the processor may classify different training sets according to a count range to which a count of historical data used for the third labels belongs, and perform cross training using the different training sets to obtain the trained model. Different count ranges may be classified according to experience. For example, if the count range is classified according to a gradient 10, the count range includes 0-10, 10-20, . . . , and so on. A label 1 and a label 2 are clamping distances obtained by averaging 78 and 80 historical data, respectively, and the count range is 70-80, then the label 1 and the label 2 are classified into the same training set. A label 3 and a label 4 are clamping distances obtained by averaging 6 and 5 historical data, respectively, and the count range is 0-10, then the label 3 and the label 4 are classified into the same training set.

In some embodiments, the training process of the distance estimation layer may be similar to the training process of the clamping model and may be found in the related descriptions above, which are not repeated here.

In some embodiments, as shown in FIG. 7, the input of the distance estimation layer 720-2 may further include an airflow speed 715 of the cooling air.

More descriptions regarding the airflow speed of the cooling air may be found on FIG. 4 and FIG. 5 and the related descriptions thereof.

Correspondingly, when the input of the distance estimation layer includes the airflow speed of the cooling air, the third training samples may further include a sample airflow speed of the cooling air.

The temperature and the cooling efficiency of the cooling air affect the cooling effect of the glass plate. When the temperature of the cooling air is high or the cooling efficiency is low, a larger airflow speed of the cooling air may be required to ensure uniform cooling of the glass plate. Therefore, when the clamping distance is determined, the airflow speed of the cooling air is considered, so as to improve the accuracy of the output of the distance estimation layer.

In some embodiments of the present disclosure, the glass cooling rate can be accurately predicted through the cooling simulation layer. Meanwhile, the clamping distance is determined by a distance prediction model, which can improve the control accuracy of the clamping device on the cooling rate and the clamping distance of the edges of the glass plate during molding, thereby optimizing the molding process of the glass plate, improving product quality, and reducing the scrap rate caused by improper clamping.

The clamping distance is determined by the clamping model, and the effects of ambient temperature, the liquid glass temperature, the glass thickness, and the liquid glass flow speed are comprehensively analyzed, which improves the prediction accuracy and reliability of the clamping distance, reduces the subsequent clamping anomaly of the primary clamping unit caused by the clamping distance, and thus improves the molding quality of the glass plate.

Some embodiments of the present disclosure further provide an operation method of a clamping device at an edge of a substrate glass during molding based on an overflow technique. The clamping device may include a primary clamping unit and a secondary edge drawing unit. The operation method may comprise during the molding of the glass plate, enabling clamping wheels of the primary clamping unit and wheels for cooling and edge drawing of the secondary edge drawing unit to clamp edges of two sides of the glass plate to make liquid glass at the edges merge and bond together to obtain a bonded glass plate; and introducing cooling air into a cooling air duct to cool edges of the bonded glass plates. More descriptions may be found in the related descriptions of FIG. 1 to FIG. 3.

In some embodiments, the clamping device may adjust a clamping distance between the primary clamping unit and the secondary edge drawing unit through a drawing part based on a processor. The clamping distance may be a vertical distance between the primary clamping unit and the secondary edge drawing unit. More descriptions may be found in the related descriptions of FIG. 5 and FIG. 6.

In some embodiments, the drawing part may include an electronic control unit, a slide rail, a pulley, and a locking part. The processor adjusting the clamping distance between the primary clamping unit and the secondary edge drawing unit through the drawing part may include controlling, through the electronic control unit, the pulley to slide in the slide rail to drive the primary clamping unit to move to adjust the clamping distance. More descriptions may be found in the related descriptions of FIG. 5 and FIG. 6.

In some embodiments, the processor may determine the clamping distance through a clamping model based on an ambient temperature, a liquid glass temperature, a glass thickness, and a liquid glass flow speed. The clamping model may be a machine learning model.

More descriptions regarding the clamping model may be found in FIG. 7 and the related descriptions thereof.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the term “some embodiments” means that a particular feature, structure, or characteristic described in connection with the embodiment is included in at least one embodiment of the present disclosure.

Therefore, it is emphasized and should be appreciated that two or more references to “some embodiments” in various portions of this specification are not necessarily all referring to the same embodiment. Furthermore, the particular features, structures, or characteristics may be combined as suitable in one or more embodiments of the present disclosure.

In some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A clamping device at an edge of a substrate glass during molding based on an overflow technique, comprising a primary clamping unit and a secondary edge drawing unit; wherein
the primary clamping unit and the secondary edge drawing unit clamp edges of two sides of a glass plate, respectively,
the primary clamping unit is arranged above the secondary edge drawing unit, and
the primary clamping unit is closer to a guide plate than the secondary edge drawing unit.

2. The clamping device of claim 1, wherein the primary clamping unit includes clamping wheels, the clamping wheels are solid roller wheels, and a material of the clamping wheels is a metal material or a ceramic material.

3. The clamping device of claim 2, wherein the clamping wheels are disposed below the guide plate.

4. The clamping device of claim 1, wherein the secondary edge drawing unit includes wheels for cooling and edge drawing, the wheels for cooling and edge drawing are hollow roller wheels.

5. The clamping device of claim 4, wherein a cooling air duct is inserted into a cavity of each of the wheels for cooling and edge drawing.

6. The clamping device of claim 5, wherein cooling air is introduced into the cooling air duct.

7. The clamping device of claim 6, wherein the cooling air duct is connected with a refrigeration device, the refrigeration device is configured to generate the cooling air, the refrigeration device is in communication with a processor, and the processor is configured to:
control the refrigeration device to generate the cooling air.

8. The clamping device of claim 7, wherein the processor is further configured to:
adjust a temperature of the cooling air by controlling a refrigeration power of the refrigeration device; and
adjust an airflow speed of the cooling air by controlling an operation parameter of a cooling fan.

9. The clamping device of claim 8, wherein the secondary edge drawing unit further includes an air outlet duct and a spiral tube, one end of the spiral tube is communicated with the cooling air duct, and the other end of the spiral tube is communicated with the air outlet duct, and the air outlet duct and the spiral tube are configured to discharge the cooling air.

10. The clamping device of claim 8, wherein the processor is further configured to:
determine the airflow speed based on the temperature of the cooling air, a liquid glass flow speed, and a glass cooling rate.

11. The clamping device of claim 1, wherein the glass plate is divided into a plurality of temperature fields in sequence from the guide plate downward according to a preset temperature range, and the primary clamping unit clamps the edge of the glass plate located in a first temperature field.

12. The clamping device of claim 1, wherein the glass plate is divided into a plurality of temperature fields in sequence from the guide plate downward according to a preset temperature range, and the secondary edge drawing unit clamps the edge of the glass plate located in a second temperature field.

13. The clamping device of claim 1, further comprising a processor and a drawing part, wherein
the processor is in communication with the drawing part,
the drawing part is connected with the primary clamping unit, and the processor is configured to:
adjust a clamping distance between the primary clamping unit and the secondary edge drawing unit by the drawing part.

14. The clamping device of claim 13, wherein the drawing part includes an electronic control unit, a slide rail, a pulley, and a locking part,
the locking part is configured to lock a position of the primary clamping unit, and
the processor is further configured to:
control, through the electronic control unit, the pulley to slide in the slide rail to drive the primary clamping unit to move to adjust the clamping distance.

15. The clamping device of claim 14, wherein the processor is further configured to:
determine the clamping distance based on an ambient temperature, a liquid glass temperature, a glass thickness, and a liquid glass flow speed through a clamping model, the clamping model being a machine learning model.

16. The clamping device of claim 15, wherein the clamping model includes a cooling simulation layer and a distance estimation layer, and the processor is further configured to:
estimate a glass cooling rate through the cooling simulation layer based on the ambient temperature, the liquid glass temperature, and the glass thickness; and
estimate the clamping distance through the distance estimation layer based on the liquid glass flow speed and the glass cooling rate.

17. An operation method of a clamping device at an edge of a substrate glass during molding based on an overflow technique, wherein the clamping device includes a primary clamping unit and a secondary edge drawing unit, wherein
the primary clamping unit and the secondary edge drawing unit clamp edges of two sides of a glass plate, respectively,
the primary clamping unit is arranged above the secondary edge drawing unit, and
the primary clamping unit is closer to a guide plate than the secondary edge drawing unit, and the operation method comprises:
during the molding of the glass plate, enabling clamping wheels of the primary clamping unit and wheels for cooling and edge drawing of the secondary edge drawing unit to clamp the edges of the two sides of the glass plate to make liquid glass at the edges merge and bond together to obtain a bonded glass plate; and
introducing cooling air into a cooling air duct to cool edges of the bonded glass plates.

18. The operation method of claim 17, wherein the clamping device includes a processor, and the operation method further comprises:
adjusting a clamping distance between the primary clamping unit and the secondary edge drawing unit by a drawing part based on the processor, the clamping distance being a vertical distance between the primary clamping unit and the secondary edge drawing unit.

19. The operation method of claim 18, wherein the drawing part includes an electronic control unit, a slide rail, a pulley, and a locking part, and the adjusting a clamping distance between the primary clamping unit and the secondary edge drawing unit by a drawing part includes:
controlling, through the electronic control unit, the pulley to slide in the slide rail to drive the primary clamping unit to move to adjust the clamping distance.

20. The operation method of claim 19, further comprising:
determining the clamping distance based on an ambient temperature, a liquid glass temperature, a glass thickness, and a liquid glass flow speed through a clamping model, the clamping model being a machine learning model.
